(19) United States
(12) Patent Application Publication
(10) Pub. No.: US 2015/0052245 A1
(43) Pub. Date: Feb. 19, 2015

(54) Methods, Apparatus and Articles of Manufacture to Monitor Media Devices

(71) Applicant: The Nielsen Company (US), LLC, Schaumburg, IL (US)

(72) Inventor: Francis Gavin McMillan, Tarpon Springs, FL (US)

(21) Appl. No.: 14/527,283

(22) Filed: Oct. 29, 2014

Related U.S. Application Data
(63) Continuation of application No. 13/836,096, filed on Mar. 15, 2013.

(51) Int. Cl. H04L 12/26

(52) U.S. Cl. CPC H04L 43/08
USPC 709/224

(57) ABSTRACT

Methods, apparatus, systems and articles of manufacture to monitor media devices are disclosed. An example media device includes a data port to receive a removable storage device; and an application instrumented to obtain first data associated with a monitoring event of the application; reference the data port to retrieve a panelist identifier from the removable storage device in response to the monitoring event; and convey the first data and the panelist identifier to a remote computer.

### RELATED APPLICATION

This patent arises from a continuation U.S. patent application Ser. No. 13/836,096, filed Mar. 15, 2013, which is hereby incorporated herein by reference in its entirety.

### FIELD OF THE DISCLOSURE

This disclosure relates generally to audience measurement and, more particularly, to method, apparatus and articles of manufacture to monitor media devices.

### BACKGROUND

In recent years, consumer devices have been provided with Internet connectivity and the ability to retrieve media from the Internet. As such, media exposure has shifted away from conventional methods of presentation, such as broadcast television, towards presentation via consumer devices accessing the Internet to retrieve media for display.

Media providers and/or other entities such as, for example, advertising companies, broadcast networks, etc. are often interested in the viewing, listening, and/or media behavior(s) of audience members and/or the public in general. To monitor these behavior(s), an audience measurement company may enlist panelists (e.g., persons agreeing to be monitored) to cooperate in an audience measurement study. The media usage and/or exposure habits of these panelists as well as demographic data about the panelists is collected and used to statistically determine the size and demographics of a larger audience of interest.

### BRIEF DESCRIPTION OF THE DRAWINGS

FIG. 1 is a block diagram of an example system constructed in accordance with the teachings of this disclosure to monitor media presentations.

FIG. 2 is a block diagram of an example implementation of the example media device of FIG. 1.

FIG. 3 is a flowchart representative of example machine readable instructions that may be executed to implement the example central facility of FIG. 1.

FIG. 4 is a flowchart representative of example machine readable instructions that may be executed to implement the example media device of FIGS. 1 and/or 2.

FIG. 5 is a block diagram of an example processing system capable of executing the example machine readable instructions of FIG. 3 to implement the example central facility of FIG. 1 and/or the example machine readable instructions of FIG. 4 to implement the example media device 108 of FIGS. 1 and/or 2.

The figures are not to scale. Wherever possible, the same reference numbers will be used throughout the drawing(s) and accompanying written description to refer to the same or like parts.

### DETAILED DESCRIPTION

Measurement of media (e.g., broadcast television and/or radio, stored audio and/or video played back from a memory such as a digital video recorder or a digital versatile disc, a webpage, audio and/or video media presented (e.g., streamed) via the Internet, a video game, etc.) often involves collection of media identifying data (e.g., signature(s), fingerprint(s), code(s), tuned channel identification information, time of exposure information, etc.) and people data (e.g., user identifiers, demographic data associated with audience members, etc.). The media identifying data and the people data can be combined to generate, for example, media exposure data indicative of number(s) and/or type(s) of people that were exposed to specific piece(s) of media.

To obtain and/or generate such information, monitoring entities monitor one or more media devices such as, for example, Internet-enabled televisions, personal computers, Internet-enabled mobile handsets (e.g., a smartphone), video game consoles (e.g., Xbox®, PlayStation® 3), tablet computers (e.g., an iPad®), digital media players (e.g., a Roku® media player, a Slingbox®, etc.), etc. Some media devices present media using browsers to retrieve and/or present media from, for example, Internet media resources. Some media devices present media using applications (sometimes referred to as “apps”) that access, retrieve, request, and/or present media (e.g., Internet media). Many different “Apps” exist and can be downloaded by users through app stores such as, for example, Apple iTunes®, Google Play®, etc. Hundreds, if not thousands, of apps are available in the app stores that enable presentation of media. Examples of such applications include, but are not limited to, Hulu®, Netflix®, HBO Go®, etc.

Some media devices that present media using apps are referred to as Over the Top (OTT) media devices. Example OTT media devices include Roku XD/S®, Xbox 360®, Playstation 3®, and D-Link Boxee®. As described in detail below, example OTT media devices implement dedicated applications (e.g., a Pandora® player, a Hulu® player, a Netflix® player, etc.) that obtain media via a network connection (e.g., a high speed Internet connection) and provide the obtained media to a presentation device native to the corresponding OTT device (e.g., video and/or audio output devices of the OTT media device) and/or a media presentation coupled to the corresponding OTT media device (e.g., a television or monitor).

Operating systems used on, for example, OTT media devices and other media devices that execute media applications, are often closed platforms. That is, the operating systems provide a limited set of functions that applications executed by the media device can access via, for example, an Application Programming Interface (API). In some operating systems, only a single app is executed at one time. When the media device executes the app, the app is typically run in a “sand-box.” That is, the app is not allowed to communicate with other applications executed by the media device. In some examples, applications have access to a limited set of functionality for sharing data with other applications.

Because communicating with applications to identify and/or monitor media presentation events on devices using a “sandbox” approach is difficult, in examples disclosed herein monitoring is enabled by adding monitoring capability to applications. In examples disclosed herein, a software development kit (SDK) is provided to distributors and/or developers of applications from, for example, an audience measurement entity (e.g., The Nielsen Company (US), LLC). Example distributors of the applications include, for example, application providers, proprietors, programmers, and/or other entities. In such instances, the SDK facilitates instrumenting and/or otherwise enabling applications (e.g., media applications (such as streaming video applications), news applications, browser applications (e.g., web browsers), image applications, social media applications, games, etc.) with monitoring functionality. The monitoring functionality enables the instrumented application to collect and transmit monitoring information (e.g., media identifying information, usage information regarding usage of the application, and/or media device identifying information) to a monitoring entity, such as the provider of the monitoring functionality. In some examples, the monitoring functionality is instrumented into the application via instruction(s) that cause the application to collect the monitoring data and to generate a request (e.g., an HTTP request) that includes the collected monitoring data (e.g., in a payload of the HTTP request). In such instances, the application is instrumented to request, for example, a resource from a Universal Resource Locator (URL) associated with the monitoring entity (e.g., a server of the monitoring entity). The generation of the request and/or the conveyance of the request is triggered by, for example, a user accessing media on the media device (e.g., hitting play on a Hulu® player). The monitoring entity receives the request and extracts the monitoring information (e.g., a video presentation, a device identifier, media identifying information, etc.) from the request. Thus, the instrumentation provided to the application cause the application to send “dummy requests” to the monitoring entity that include monitoring data associated with the application.

In some examples, application developers create applications that include the monitoring functionality using the SDK and/or add monitoring functionality to existing applications using the SDK. Accordingly, rather than relying on a cross-application monitoring client that monitors a plurality of applications executing on a media device (which may not be possible for some media devices, such as certain OTT media devices), instrumented applications disclosed herein are instrumented with instructions such that the individual applications effectively monitor themselves. In some examples, the instrumented application is referred to as a monitoring-enabled application. Because the instrumented applications monitor themselves, the instrumented applications and/or the monitoring functionality enables the instrumented application to, for example, notify a central facility associated with the monitoring entity when the instrumented application is used, provide the central facility with media identifying information associated with the application usage, provide the central facility with an identity of the application and/or the media device, inform the central facility as to a manner in which the application is presenting the media (e.g. via a native display of an OTT media device, via a television coupled to an OTT media device, etc.), provide the central facility with a duration of application usage (e.g., a period of time associated with exposure to the identified media), and/or additional or alternative information. An example system for performing monitoring such as that discussed above is disclosed in U.S. patent application Ser. No. 13/828,971, filed Mar. 14, 2013, entitled “Methods and Apparatus to Monitor Media Presentations”, which is hereby incorporated by reference in its entirety.

While monitoring-enabled applications executing on, for example, an OTT media device provide application identifying information associated with an accessed application and/or media identifying information indicative of accessed media, obtaining user identification information associated with the corresponding users or audience members presents challenges. That is, application and/or media identifying information is captured but the corresponding people data is difficult to obtain when, for example, the application is executing on an OTT media device. For example, application developers using SDKs to instrument such applications are not aware of and do not have access to specific user identifying information because the instrumented applications are distributed to different users (e.g., via an app store). Thus, the instrumented applications do not include user identifiers that can be associated with the monitoring data (e.g., media identifying data). Further, while manufacturers may assign a hardware based user identifier (e.g., a hardware based key assigned to a device by a vendor) to a particular media device, monitoring entities receiving media identifying information associated with usage of the particular media device (e.g., via the instrumented application) are unaware of a correspondence between the hardware based user identifier and an actual person and/or household. In such instances, mapping the vendor assigned identifiers to particular persons and/or households is a difficult, cost ineffective, task for the monitoring entities that is likely to result in high rates of inaccurate data correlations.

Example methods, apparatus, and/or articles of manufacture disclosed herein provide monitoring entities accurate, cost effective and user friendly techniques for identifying users and/or audience members associated with application usage and/or presentation of media on, for example, OTT media devices. As described in detail below, examples disclosed herein collect information (e.g., as part of a registration process for a monitoring panel) related to a panelist (e.g., a person and/or household family registered with a monitoring panel), assign a panelist identifier to the panelist, and store the collected information with the panelist identifier (e.g., in a central database). As used herein, the term “panelist” refers to a single person and/or a group of people, such as a household. For example, a household including four people may be referred to as a “panelist.” Accordingly, a panelist identifier may refer to a single person and/or a group of people, such as a household.

Examples disclosed herein provide the panelist with one or more removable storage devices each containing data representative of the panelist identifier assigned to the panelist. Example removable storage devices include Universal Serial Bus (USB) drives, Secure Digital (SD) cards, Mulit Media Cards (MMC) cards, etc. In some examples, the removable storage device(s) are mailed to the panelist in response to the panelist agreeing to participate in the panel and/or in response to the panelist obtaining a media device that executes one or more apps, such as an OTT media device. For example, when the panelist owns and/or has access to one or more media devices that executes one or more apps as described above (e.g., a Hulu® application installed on an OTT media device, such as a Roku® device), example removable storage device(s) disclosed herein are provided to the panelist. In some examples disclosed herein, a type of removable storage provided to the panelist depends on a type of the media device of the panelist. For example, some OTT media devices support SD cards but not USB devices. In such instances, the removable storage device provided to the panelist by examples disclosed herein is an SD card. In some examples, the media device of the panelist supports different types of removable storage devices. In such instances, examples disclosed herein provide each type of supported removable storage device and/or select which type of removable storage device to provide (e.g., based on cost).

Examples disclosed herein request the panelist to install (e.g., plug in) the removable storage device on such media devices. For example, OTT media devices typically include at least one USB port to receive a USB device, such as a thumb drive. In such instances, examples disclosed herein provide the panelist with a USB drive having the corresponding panelist identifier stored on memory of the USB drive. The panelist is requested to plug the USB drive into the USB port of the OTT media device.

To utilize the removable storage device to identity the panelist in connection with user interaction(s) with the application (e.g., a user hitting play on a user interface of a Hulu® player), examples disclosed herein provide the application with example instrumentation disclosed herein (e.g., via a software development kit (SDK)). The instrumentation provided by examples disclosed herein cause the application(s) to reference (e.g., query or poll) the removable storage device in response to one or more monitoring events such as, for example, the application being initiated, the application being used, a piece of media being accessed via the application, data being posted to a social networking site via the application, and/or any other desired event. In other words, examples disclosed herein instrument the application such that the application queries a port (e.g., a USB receptacle) of the media device to which the example removable storage device disclosed herein is coupled. The instrumentation provided to the applications by examples disclosed herein causes the application to obtain the panelist identifier stored on the removable storage device and to associate the panelist identifier with information related to the triggering monitoring event. The information related to the triggering monitoring event is referred to herein as monitoring data and includes, for example, media identifying information indicative of accessed media, an identity of the application, a device identifier corresponding to the media device, usage information associated with the triggering use of the application, etc.). In some instances, the panelist identifier obtained via examples disclosed herein is considered and/or referred to as monitoring data. The instrumentation provided to the applications by examples disclosed herein causes the panelist identifier and/or the monitoring data to be conveyed to, for example, the monitoring entity that provided the panelist with the removable storage device. For example, when monitoring functionality of the application includes generation and conveyance of URL requests to a server of the monitoring entity, examples disclosed herein provide instrumentation to the application such that the application queries the removable storage devices disclosed herein and adds the obtained panelist identifier to the generated URL request. In other words, examples disclosed herein instrument the application to obtain panelist data and to incorporate the panelist data into the URL request that is utilized to convey data to, for example, a monitoring entity.

Thus, examples disclosed herein enable monitoring entities to collect people data (e.g., user identifiers, demographic information, etc.) in addition to, for example, media identifying information and/or application usage information described above in connection with, for example, OTT media devices and/or other media presentation devices executing one or more applications (e.g., media players and/or social networking applications). Examples disclosed herein provide cost effective methods and apparatus to collect people data in connection with devices (e.g., OTT media devices) and/or circumstances that restrict and/or prohibit collection of such data.

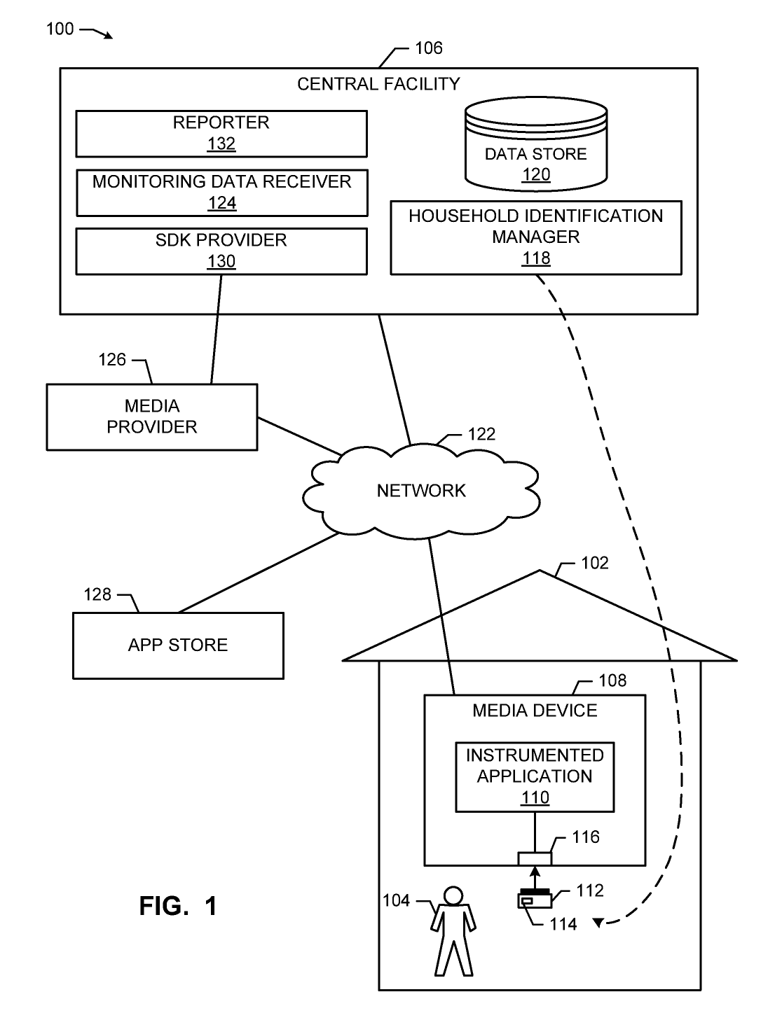

FIG. 1 is a block diagram of an example system 100 constructed in accordance with the teachings of this disclosure. The example system 100 of FIG. 1 includes a household 102 including at least one person 104 that has agreed to be a panelist in a panel (e.g., a media measurement panel, a consumer activity measurement panel, a behavior measurement panel, etc.) implemented by a monitoring entity (e.g., The Nielsen Company (US), LLC) associated with a central facility 106. The example household 102 of

FIG. 1 includes a media device 108 that executes one or more applications (“apps”) 110, one of which is shown in FIG. 1. As described in detail below, the example household 102 is provided with (e.g., via a mailed package from the central facility 106 and/or in connection with a purchase of the media device 108) a removable storage device 112 (e.g., a USB drive, an SD card, an MMC card, etc.) including a panelist identifier 114 assigned to (e.g., by the central facility 106) the panelist 104 and/or the household 102. In the illustrated example of FIG. 1, the panelist 104 is requested (e.g., by the central facility 106) to couple the example removable storage device 112 of FIG. 1 to a counterpart data port 116 (e.g., a USB port, memory card slot, etc.) of the example media device 108. The example removable storage device 112 has a part (e.g., projection) to be removably coupled to the data port 116, which is an external data port in the illustrated example. In some examples, the request includes information indicating that plugging the example removable storage device 112 of FIG. 1 into the data port 116 of the media device 108 will be considered consent to monitor the application 110 and/or the media device 108. In such instances, compliance with the request from the central facility 106 to insert the example removable storage device 112 into the data port 116 is treated as consent by the central facility 106. In some example, the monitoring functionality instrumented into the application 110 does not become active until the consent (e.g., by the panelist 104 plugging in the removable storage device 112) is provided by the panelist 104. In particular, as described in detail below, the example application 110 of FIG. 1 is instrumented (e.g., provided with one or more instructions by the example central facility 106) to provide the central facility 106 with data related to usage of the application 110 (e.g., to present media, interact with a social network, etc.) by, for example, generating and conveying a request (e.g., an HTTP request) to a computer (e.g., server) associated with the central facility 106 when one or more monitoring events (e.g., the application 110 being used to present media, interact with a social network, etc.) are detected. Additionally, the example application 110 of FIG. 1 is instrumented to query the data port 116 to obtain the panelist identifier 114 from the removable storage device 112 when, for example, the one or more monitoring events are detected. In the illustrated example of FIG. 1, the panelist identifier 114 of FIG. 1 is conveyed to the central facility 106 in connection with the detected monitoring event(s) (e.g., by incorporating the panelist identifier 114 into an HTTP dummy request destined for the central facility 106), thereby providing the central facility 106 with panelist identification information associated with, for example, usage of the application 110 and/or media accessed via the application 110.

To prepare the example removable storage device 112 of FIG. 1 for conveyance to the example household 102 and/or to track the example removable storage device 112 of FIG. 1, the example central facility 106 of FIG. 1 includes a panelist identification manager 118. In some examples, the example panelist identification manager 118 of FIG. 1 receives demographic information from, for example, the panelist 104 of FIG. 1. In some examples, the panelist identification manager 118 receives the demographic information as part of a registration process (e.g., via a survey presented to the panelist 104) associated with the panel, as part of a purchase of the media device 108, as part of a warranty registration for the media device 108 and/or as part of an acquisition (e.g., download and/or installation) of the example application 110 of FIG. 1. The example panelist identification manager 118 of FIG. 1 stores the demographic information and/or any other suitable information related to the panelist 104 and/or the household 102 in a data store 120. Additionally, the example panelist identification manager 118 of FIG. 1 assigns the panelist identifier 114 of FIG. 1 to the panelist 104 and/or the household 102. The example panelist identifier 114 of FIG. 1 is any suitable identifier such as, for example, an alphanumeric identifier. The example panelist identifier 114 of FIG. 1 is stored in the data store 120 in connection with, for example, the demographic information associated with the panelist 104 and/or the household 102.

In the illustrated example of FIG. 1, the panelist identification manager 118 facilitates the panelist identifier 114 being placed onto (e.g., stored on) the example removable storage device 112. In some examples, the panelist identification manager 118 encrypts the panelist identifier 114 prior to storing the identifier 114 (or an encrypted form of the identifier) on the example removable storage device 112. Encrypting the panelist identifier 114 ensures that sensitive panelist information is not exposed to applications that would otherwise attempt to gain access to sensitive panelist information. Accordingly, instrumented applications do not have access to panelist information other than the panelist identifier 114 which, while identifying the panelist 104, does not identify any sensitive information about the panelist 104 (e.g., a telephone number, an email address, a mailing address, a social security number, a credit card number, etc.).The example panelist identification manager 118 of FIG. 1 also facilitates conveyance of the removable storage device 112 having the panelist identifier 114 stored thereon to the household 102. In the illustrated example of FIG. 1, the panelist identification manager 118 facilitates mailing of the removable storage device 112 to the household 102. However, any suitable type of delivery can be utilized. The example panelist identification manager 118 of FIG. 1 triggers mailing of the removable storage device 112 in response to the panelist 104 agreeing to join the panel, a purchase of the media device 108, an acquisition (e.g., download) of the application 110, and/or any other appropriate event. The example panelist identification manager 118 of FIG. 1 includes instructional information with the mailing to request the panelist 104 to install (e.g., plug in) the removable storage device 112 in the data port 116 of the media device 108.

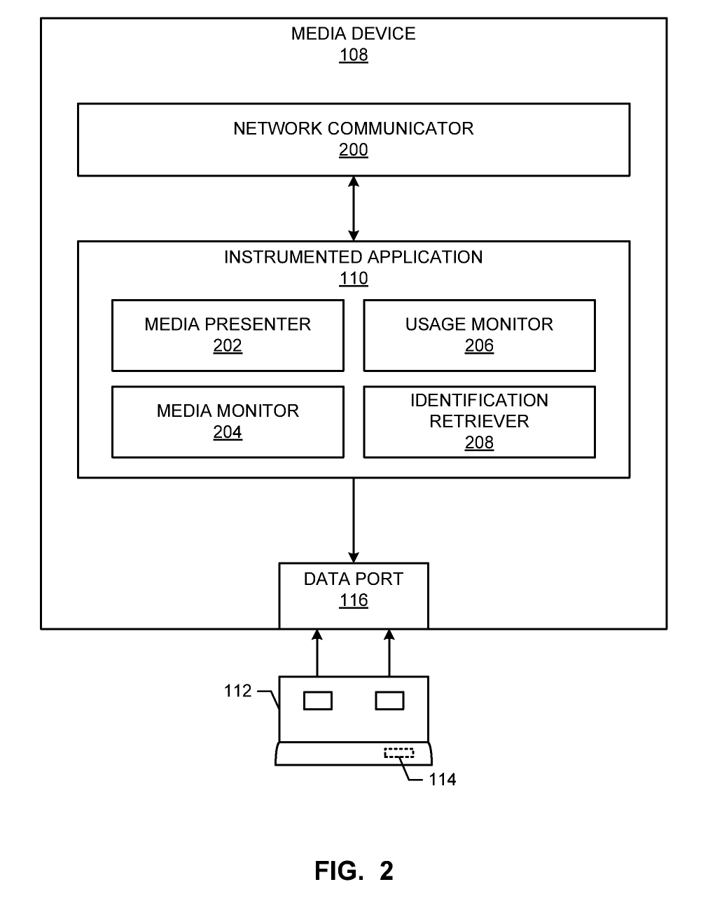

In the example of FIG. 1, the instrumented application 110 has access to the panelist identifier 114 of the removable storage device 112 via the data port 116. As described in detail below in connection with FIG. 2, access to the example removable storage device 112 of FIG. 1 enables the instrumented application 110 to provide the panelist identifier 114 to the central facility 106 in connection with detected monitoring events associated with the instrumented application 110 (e.g., to present media and/or interact with a social network such as Facebook® and/or Twitter®). For example, the media device 108 of FIG. 1 communicates with the central facility 106 via a network 122. The example network 122 of FIG. 1 is a wide area network (WAN) such as the Internet. However, in some examples, local networks may additionally or alternatively be used. For example, multiple networks (e.g., a cellular network, an Ethernet network, etc.) may be utilized to implement the example network 122 of FIG. 1.

The example central facility 106 includes a monitoring data receiver 124 to receive information, such as monitoring data and/or the panelist identifier 114, from the media device 108. The example monitoring data receiver 124 of FIG. 1 includes an HTTP (Hypertext Transfer Protocol) interface to receive HTTP requests that include data provided by the example media device 108 of FIG. 1. In particular, HTTP requests are sent with the monitoring information (e.g., media identifying information, application usage information, the panelist identifier 114, etc.) and/or the panelist identifier 114 in payloads of the HTTP requests. In some examples, the HTTP requests are not intended to actually retrieve content, but are instead used as a vehicle to convey data. Thus, the HTTP requests may be referred to as “dummy requests”. The example monitoring data receiver 124 of FIG. 1 includes software (e.g., a daemon) to extract data from the payload of the dummy request(s). Additionally or alternatively, any other method(s) to transfer data may be used such as, for example, an HTTP Secure protocol (HTTPS), a file transfer protocol (FTP), a secure file transfer protocol (SFTP), an HTTP and/or HTTPS GET request, an HTTP and/or HTTPS POST request, etc.

As disclosed herein, monitoring data provided by the monitoring functionality of the instrumented application 110 includes, for example, media-identifying information (e.g., media-identifying metadata, code(s), signature(s), watermark(s), and/or other information that may be used to identify presented media) and/or application usage information (e.g., an identifier of an application, a time and/or duration of use of the application, a rating of the application, etc.). In some examples, the monitoring data receiver 124 of FIG. 1 receives an encrypted version of the panelist identifier 114. In such instances, an encryption key is provided to the monitoring data receiver 124 such that the received panelist identifier 114 can be decrypted. The example monitoring data receiver 124 of FIG. 1 stores the panelist identifier 114 in connection with the corresponding monitoring information received from the media device 108 in the data store 120. For example, an entry or record of the data store 120 includes monitoring information indicative of media accessed via the application 110 and the panelist identifier 114 retrieved by the application 110 from the data port 116 in response to the access of the media.

The example media device 108 of FIG. 1 accesses a plurality of media sources via, for example, the network 122. The example of FIG. 1 includes a media provider 126 to which the example media device 108 has access. In some examples, the media provider 126 is a server from which the example instrumented application 110 of FIG. 1 is configured to retrieve media. For example, when the instrumented application 110 of FIG. 1 corresponds to a Hulu® player, the example media provider 126 may correspond to a Hulu® server with which the instrumented application 110 is designed to communicate. Additionally or alternatively, the example media provider 126 is a source of different types of media (e.g., web pages, audio, video, images, etc.). The example media provider 126 of FIG. 1 may be implemented by any provider(s) of media such as a digital media broadcaster, multicaster, or unicaster (e.g., a cable television service, a fiber-optic television service, an IPTV provider, etc.) and/or an on-demand digital media provider (e.g., an Internet streaming video and/or audio services such as Netflix®, YouTube®, Hulu®, Pandora®, Last.fm®, etc.), a web page, and/or any other provider of media. Additionally or alternatively, the example media provider 126 may not be an Internet provider. For example, the media providers may be on a private, a virtual private, and/or semi-private network (e.g., a LAN).

The example of FIG. 1 includes an app store 128 that provides media devices (e.g., the media device 108 of FIG. 1) with access to a plurality of applications (e.g., apps) for download. The example app store 128 of FIG. 1 may be any repository of applications such as, for example, the Apple® App Store, Google Play®, the Windows® Phone app store, the Ubuntu Software Center®, etc. In some examples, the media provider 126 provides the app store 128 with one or more applications designed to retrieve media from, for example, a server associated with the media provider 126. The example panelist 104 of FIG. 1 accesses the app store 128 and/or any other source of applications via the media device 108 such that desired applications can be purchased, downloaded, and/or installed on the media device 108. In some examples, the media device 108 already includes one or more applications when the media device 108 is acquired by the panelist 104.

The example media device 108 of FIG. 1 uses the example application 110 of FIG. 1 to retrieve media from, for example, the media provider 126 for presentation. In some examples, the media device 108 is capable of directly presenting media (e.g., via a display). Additionally or alternatively, the media device 108 of FIG. 1 conveys the retrieved media on separate media presentation equipment (e.g., speakers, a display, etc.). For example, the media device 108 of the illustrated example is an OTT media device, such as an Apple TV® box, that routes media obtained from the media provider 126 (e.g., an Apple TV® server) to a television of the household 102. However, the example media device 108 of FIG. 1 can be implemented by any other suitable media device, such as a smart television, a video game console (e.g., Xbox 360®, PlayStation 3®, etc.) or a different OTT media device (e.g., a Roku® media player, a Slingbox®, etc.).

As described above, the application 110 is instrumented to include monitoring functionality provided by, for example, the monitoring entity associated with the central facility 106. As disclosed herein, the monitoring functionality of the instrumented application 110 causes the example media device 108 to transmit data (e.g., media identifying information, application usage information, the panelist identifier 114, etc.) to the central facility 106 (e.g., via HTTP dummy requests having payloads including the monitoring data and/or the panelist identifier 114). In the illustrated example of FIG. 1, the central facility 106 includes an SDK provider 130 to generate and/or otherwise provide a monitoring SDK (e.g., to the media provider 126 or other entity) to facilitate integration of the monitoring functionality into the instrumented application 110. In the example of FIG. 1, the SDK provider 130 makes the monitoring SDK available to application developers associated with, for example, the media provider 126. In the illustrated example, the application developers of the media provider 126 instrument one or more new or existing applications (e.g., the instrumented application 110 of FIG. 1) with data (e.g., one or more scripts, programs, instructions, etc.) from the monitoring SDK. In some examples, the media provider 110 posts the instrumented application(s) to the app store 128. With the instrumented application 110 available at the app store 128, members of the general public, such as the panelist 104 of FIG. 1, may download the instrumented application to one or more media device(s), such as the example media device 108 of FIG. 1.

While in the example of FIG. 1 the application 110 of FIG. 1 is instrumented with the monitoring functionality via the monitoring SDK, the monitoring functionality disclosed herein may be provided to the application 110 via any additional or alternative manner and/or by any additional or alternative source. In some examples, the central facility 106 of FIG. 1 conveys the monitoring instrumentation to the application 110 when the application 110 is already installed in the media device 108 via, for example, an update to be executed by the application 110. Additionally or alternatively, the monitoring instrumentation may be provided as an application programming interface (API), a plugin, an add-on, etc.

With the monitoring functionality provided by the central facility 106 of FIG. 1 instrumented into the application 110 of FIG. 1, the application 110 can monitor itself and report data to the central facility 106. In addition to detecting application usage data and/or media identifying data associated with the instrumented application 110, the example monitoring functionality provided by the example central facility 106 of FIG. 1 causes the instrumented application 110 to retrieve the panelist identifier 114 from the example removable storage device 112 of FIG. 1. An example implementation of monitoring functionality provided to the instrumented application 110 by, for example, the SDK provider 130 of FIG. 1 is described in detail below in connection with FIG. 2.

The example central facility 106 of FIG. 1 includes a reporter 132 to generate, for example, media exposure metrics and/or application usage metrics based on data provided by the instrumented application 110 and/or other instrumented applications (e.g., of the example household 102 of FIG. 1 and/or different households). For example, the reporter 132 of FIG. 1 compiles media exposure metrics based on a correlation of the media identifying information, the application usage information, and/or the user identifying information provided by, for example, the panelist identifier 114 supplied via the example removable storage device 112 of FIG. 1. A report is then generated to indicate media exposure and/or application usage statistics. In some examples, the exposure measurements provide ratings information for different media (e.g., a particular television show, a particular website, a particular movie, etc.). In some examples, the exposure measurements indicate ratings information and/or usage statistics for different instrumented applications.

To enable generation of detailed metric(s) based on people data associated with the detected application usage, the example reporter 132 utilizes the panelist identifier 114 provided by the example removable storage device 112 of FIG. 1. That is, without the example removable storage device 112 and the panelist identifier 114 stored thereon, the example reporter 132 would not have access to data regarding the user(s) associated with detected media and/or application usage. For example, the reporter 132 of FIG. 1 generates report(s) that associate media exposure metrics with demographic segments (e.g., age groups, genders, ethnicities, etc.) corresponding to the user(s) of media device(s). Additionally or alternatively, the reporter 132 of FIG. 1 may associate media exposure metrics with metric indicators of the popularity of the artist, genre, song, title, etc., across one or more user characteristics selected from one or more demographic segment(s), one or more age group(s), one or more gender(s), and/or any other user characteristic(s). Additionally or alternatively, the reporter 132 of FIG. 1 uses media exposure metrics to determine demographic reach of streaming media, ratings for streaming media, engagement indices for streaming media, user affinities associated with streaming media, broadcast media, and/or any other audience measure metric associated with streaming media and/or locally stored media. While in the illustrated example, the media exposure metrics are used to provide information for streaming media, the media exposure metrics may be used to provide information for any other type of media such as, for example, websites, non-streaming media, etc. In some examples, the media exposure metrics are audience share metrics indicative of percentages of audiences for different applications and/or types of applications that accessed the same media. For example, a first percentage of an audience may be exposed to news media via a browser application, while a second percentage of the audience may be exposed to the same news media via a news reader application.

Generation of such reports (e.g., reports based on, including and/or incorporating demographic information) in connection with certain devices (e.g., OTT media devices) is enabled by the example removable storage device 112, the panelist identifier 114 stored on the removable storage device 112, and/or the instrumentation of the application 110 to retrieve the panelist identifier 114 in connection with usage of the application 110.

In some examples, the type of information collected by the monitoring functionality of the application 110 depends on whether consent to monitor has been received. For example, demographic information related to the panelist 104 may be collected in connection with, for example, media identifying information and/or application usage information only if consent is provided. In such instances, media identifying information and/or application usage information is collected by the application 110 and conveyed to the central facility 106 when consent is not received, but demographic data and/or panelist information is not collected and/or conveyed to the central facility 106. While the example panelist 104 of FIG. 1 has agreed to join the panel and, thus, provided at least some consent to monitor the media device 108, additional consent may be required to have demographic information and/or other types of personal information collected.

Although for simplicity, the above discussion focuses on a single media device 108, a single instrumented application 110, a single media provider 126, a single app store 128, and a single central facility 106, any number of any of these elements may be present. For example, in a typical implementation, it is expected that multiple media providers will offer multiple different instrumented applications to the public at large. Thus, it is expected that there will be many media devices accessing such applications, and that a significant portion of the users will agree to be panelists. Thus, it is expected that there will be many instances of the above processes conducted across many devices at overlapping and/or distinct times. Thus, for example, there may be many instantiations of the examples disclosed herein operating at the same or different time. Some of these instances may be implemented as parallel threads operating on a same device.

While an example manner of implementing the central facility 106 is illustrated in FIG. 1, one or more of the elements, processes and/or devices illustrated in FIG. 1 may be combined, divided, re-arranged, omitted, eliminated and/or implemented in any other way. Further, the example panelist identification manager 118, the example monitoring data receiver 124, the example SDK provider 130, the example reporter 132 and/or, more generally, the example central facility 106 of FIG. 1 may be implemented by hardware, software, firmware and/or any combination of hardware, software and/or firmware. Thus, for example, any of the example panelist identification manager 118, the example monitoring data receiver 124, the example SDK provider 130, the example reporter 132 and/or, more generally, the example central facility 106 of FIG. 1 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example, panelist identification manager 118, the example monitoring data receiver 124, the example SDK provider 130, the example reporter 132 and/or, more generally, the example central facility 106 of FIG. 1 is/are hereby expressly defined to include a tangible computer readable storage device or storage disk such as a memory, a digital versatile disk (DVD), a compact disk (CD), a Blu-ray disk, etc. storing the software and/or firmware. Further still, the example central facility 106 of FIG. 1 may include one or more elements, processes and/or devices in addition to, or instead of, those illustrated in FIG. 1, and/or may include more than one of any or all of the illustrated elements, processes and devices.

FIG. 2 is a block diagram of an example implementation of the example media device 108 of FIG. 1. The example media device 108 of FIG. 2 includes the example instrumented application 110 of FIG. 1 and the example data port 116 of FIG. 1. As described above, the example data port 116 of FIG. 2 is a receptacle constructed to receive, for example, the removable storage device 112. In some examples, the data port 116 is a USB port and the removable storage device 112 is a USB drive storing the panelist identifier 114. In the example media device of FIG. 2, the instrumented application 110 has access to (e.g., is in communication with and is privileged to obtain data from) the example data port 116 and/or a device coupled (e.g., removably) to the data port 116 such as the removable storage device 112.

The example media device 108 of FIG. 2 includes a network communicator 200 to enable the media device 108 to communicate via, for example, the network 122 of FIG. 1. Additionally or alternatively, the example network communicator 200 may place the media device 108 in communication with, for example, the central facility 106 and/or the media provider 126. In the illustrated example of FIG. 1, the network communicator 200 is an Ethernet interface. In the illustrated example, the network communicator 200 transmits monitoring data and/or user identifying information obtained via the instrumented application 100 to the central facility 106. In some examples, the data is transmitted to the central facility 106 using one or more HTTP requests. For example, the HTTP request may be a dummy request in that it is not intended to receive data, but rather is used as a vehicle to carry monitoring data (e.g., the panelist identifier 114, media identifying information, device identifying information, application identifying information, application usage information, etc.) to the central facility 106. However, any other way of transmitting data may additionally or alternatively be used such as, for example, a file transfer protocol (FTP), etc.

In the illustrated example of FIG. 2, the instrumented application 110 includes a media presenter 202 to present data to a user (e.g., the panelist 104). The example media presenter 202 of FIG. 2 interacts with a an application programming interface (API), such as a QuickTime® API or an Adobe® Flash® media presentation framework, to display media via the media device 108. In some examples, the media presenter 202 interacts with one or more media presentation devices separate from the media device 108, such as a television and/or an audio output system. In such instances, the media presenter 202 outputs data, such as media data received from the media provider 126, to the separate media presentation devices.

The example media device 108 of FIG. 2 includes a media monitor 204 to monitor the media presenter 202, for example. In the illustrated example of FIG. 2, the media monitor 204 implements monitoring functionality provided by, for example, the central facility 106. For example, the media monitor 204 may be implemented by one or more instrumentation instructions provided in an SDK associated with the example SDK provider 130 of FIG. 1. The example media monitor 204 of FIG. 2 analyzes information output by the media presenter 202 to obtain (e.g., detect and/or extract) media identifying information associated with the media output by the media presenter 202. For example, the media monitor 204 of FIG. 2 extracts metering data (e.g., signature(s), watermark(s), code(s), etc.) from the media presented by the media presenter 202. Audio watermarking is a technique used to identify media such as television broadcasts, radio broadcasts, advertisements (television and/or radio), downloaded media, streaming media, prepackaged media, etc. Audio watermarking techniques identify media by embedding one or more audio codes (e.g., one or more watermarks), such as media identifying information and/or an identifier that may be mapped to media identifying information, into an audio and/or video component. In some examples, the audio or video component is selected to have a signal characteristic sufficient to hide the watermark. As used herein, the terms “code” or “watermark” are used interchangeably and are defined to mean any identification information (e.g., an identifier) that may be inserted or embedded in the audio or video of media (e.g., a program or advertisement) for the purpose of identifying the media or for another purpose such as tuning (e.g., a packet identifying header). As used herein “media” refers to audio and/or visual (still or moving) content and/or advertisements. To identify watermarked media, the watermark(s) are extracted and used to access a table of reference watermarks that are mapped to media identifying information.

Unlike media monitoring techniques based on codes and/or watermarks included with and/or embedded in the monitored media, fingerprint or signature-based media monitoring techniques generally use one or more inherent characteristics of the monitored media during a monitoring time interval to generate a substantially unique proxy for the media. Such a proxy is referred to as a signature or fingerprint, and can take any form (e.g., a series of digital values, a waveform, etc.) representative of any aspect(s) of the media signal(s)(e.g., the audio and/or video signals forming the media presentation being monitored). A good signature is one that is repeatable when processing the same media presentation. Preferably, the signature is unique relative to other (e.g., different) presentations of other (e.g., different) media. However, in some examples, a series of signatures are captured because any one signature may not be unique in and of itself The terms “fingerprint” and “signature” are used interchangeably herein and are defined herein to mean a proxy for identifying media that is generated from one or more inherent characteristics of the media.

Signature-based media monitoring generally involves determining (e.g., generating and/or collecting) one or more signature(s) representative of a media signal (e.g., an audio signal and/or a video signal) output by a monitored media device and comparing the monitored signature(s) to one or more references signatures corresponding to known (e.g., reference) media sources. Various comparison criteria, such as a cross-correlation value, a Hamming distance, etc., can be evaluated to determine whether a monitored signature matches a particular reference signature. When a match between the monitored signature(s) and the reference signature(s) is found, the monitored media can be identified as corresponding to the particular reference media represented by the reference signature(s) that matched the monitored signature. Because attributes, such as an identifier of the media, a presentation time, a broadcast channel, etc., are collected for the reference signature, these attributes may then be associated with the monitored media whose monitored signature(s) matched the reference signature(s). Example systems for identifying media based on codes and/or signatures are described in Thomas, U.S. Pat. No. 5,481,294, which is hereby incorporated by reference in its entirety. In some examples, the code/watermark is transmitted with and/or in association with the media as media-identifying metadata. The media-identifying metadata may be formatted in a text or binary format such as, for example, an ID3 tag. In some examples, the media-identifying metadata includes the data from the code/watermark, etc. However, in some other examples, the media-identifying metadata is derived from and/or representative of the code/watermark, and/or a signature, etc. Example methods and apparatus to transcode watermarks into ID3 tags are disclosed in U.S. patent application Ser. No. 13/341,646, which was filed on Dec. 30, 2011, U.S. patent application Ser. No. 13/341,661, which was filed on Apr. 10, 2012, U.S. patent application Ser. No. 13/443,596, which was filed on Apr. 10, 2012, U.S. patent application Ser. No. 13/455,961, which was filed on Apr. 25, 2012, U.S. patent application Ser. No. 13/341,646, which was filed on Dec. 30, 2011, and U.S. patent application Ser. No. 13/472,170, which was filed on May 15, 2012. U.S. patent application Ser. No. 13/341,646, U.S. patent application Ser. No. 13/341,661, U.S. patent application Ser. No. 13/443,596, U.S. patent application Ser. No. 13/455,961, U.S. patent application Ser. No. 13/341,646, and U.S. patent application Ser. No. 13/472,170 are hereby incorporated by reference in their entireties.

In the illustrated example of FIG. 2, the media monitor 202 determines (e.g., extracts, transforms, derives, decodes, converts, etc.) the media-identifying metadata (e.g., such as media identifying information, source identifying information, watermarks, codes, etc.) associated with, and/or transmitted with the media (e.g., in an ID3 tag, in a Hypertext Transfer Protocol (HTTP) Live Streaming (HLS) manifest, in an Moving Pictures Experts Group version 2 (MPEG2) transport stream, in a timed text track, in an encryption key associated with the media, etc.). The media-identifying metadata may be a code (e.g., watermark) in, for example, a text or binary format located in an ID3 tag associated with the media. In some examples, the media monitor 202 converts the metering data into a text and/or binary format for transmission to the central facility 106.

The example instrumented application 110 of FIG. 2 includes a usage monitor 206 to detect and/or measure one or more user interactions with the application 110. The type(s) of user interactions that the example usage monitor 206 detects depends on, for example, a type and/or purpose of the application 110. For example, when the example application 110 of FIG. 2 corresponds to a media player, the example usage monitor 206 determines media presentation session information associated with instances of media access and/or presentation. For example, the usage monitor 206 of FIG. 2 identifies a start time, end time, duration, download characteristic(s), etc. associated with media being presented via the example media presenter 202. The example usage monitor 206 of FIG. 2 obtains such data by, for example, analyzing log data associated with the application 110 and/or inputs provided to the application 110 by the user. Additionally or alternatively, the example application 110 may provide access to, for example, one or more social networking sites and/or services (e.g., Facebook®, Twitter®, etc.). In such instances, the example usage monitor 206 of FIG. 2 identifies which social networking site and/or services is accessed via the application 110, which actions (e.g., posting, messaging, liking, unliking, friending, de-friending) were performed via the application 100, a time of an interaction with the social networking site and/or service, and/or any other additional or alternative usage information. While media presentation usage information and social networking usage information are described above, the example usage monitor 206 of FIG. 2 can monitor any suitable type of application for any suitable type of usage information.

The example instrumented application 110 of FIG. 1 includes an identification retriever 208 to query the data port 116 of the media device 108 such that the panelist identifier 114 is retrieved. In the illustrated example of FIG. 2, the identification retriever 208 is triggered to query the data port 116 in response to an event associated with the application 110, such as a monitoring event. In some examples, the identification retriever 208 of FIG. 2 is implemented as instruction(s) added to monitoring functionality of the application 110 that causes the generation and conveyance of the HTTP requests used by the network communicator 200 to convey data to the central facility 106. For example, in addition to triggering the collection of monitoring data to be included in a dummy HTTP request, certain monitoring events trigger the identification retriever 208 to query the data port 116 such that the panelist identifier 114 is included in the dummy HTTP request with the collected monitoring data. Example monitoring events include the example media monitor 204 detecting media being presented by the presenter 202, the example media monitor 204 determining that media has been requested (e.g., that a play button associated with the media presenter 202 has been pressed), the example usage monitor 206 determining that the application 110 has been initialized, the example usage monitor 206 determining that the application 110 was used to exchange data with a social networking site and/or service, and the example usage monitor 206 determining that a session of the application 110 has been terminated. The example identification retriever 208 of FIG. 2 communicates with the data port 116 in response to a monitoring event such that user identifying information can be obtained for the detected monitoring event. That is, the example identification retriever 208 of FIG. 2 enables the application 110 to attribute the detected monitoring event to a particular user, such as the panelist 104 and/or the household 102. In particular, the example identification retriever 208 of FIG. 2 queries the data port 116 to obtain the panelist identifier 114 from the example removable storage device 112. In some examples, the identification retriever 208 of FIG. 2 receives an encrypted version of the panelist identifier 114 from the removable storage device 112. In the illustrated example, the example identification retriever 208 conveys the encrypted panelist identifier 114 to the example central facility 106, which decrypts the panelist identifier 114 (e.g., via the monitoring data receiver 124).

The example identification retriever 208 of FIG. 2 associates the obtained panelist identifier 114 with the monitoring data associated with, for example, the triggering monitoring event. For example, a same label and/or timestamp is assigned to the obtained panelist identifier 114 and the corresponding monitoring data. Additionally or alternatively, the identification retriever 208 of FIG. 2 packages the panelist identifier 114 with the corresponding monitoring data to form a labeled data packet.

In some examples, the media device 108 includes persistent memory. For example, certain video game consoles (e.g., Xbox 360® and PlayStation 3®) include disk storage. In some such examples, the identification retriever 208 retrieves the panelist identifier 114 and the stores the panelist identifier 114 (e.g., an encrypted version of the panelist identifier 114) on the persistent memory of the media device 108. In such instances, the example identification retriever 208 responds to the monitoring events described above by querying the persistent memory of the media device 108 to obtain the panelist identifier 114. If the panelist identifier 114 cannot be obtained from the persistent memory of the media device 108 (e.g., the memory has been corrupted or overwritten), the example identification retriever 208 of FIG. 2 references the data port 116 to obtain the panelist identifier 114 from the removable storage device 112. However, in some examples, the media device 108 does not include or provide access to persistent memory on which the panelist identifier 114 may be stored. In such instances, the example identification retriever 208 does not store the panelist identifier 114 on the media device 108.

The example identification retriever 208 of FIG. 2 provides the information (e.g., the panelist identifier 114, the monitoring data, and/or a data packet including the panelist identifier 114 and the monitoring data) to the network communicator 200 of FIG. 2. The example network communicator 200 of FIG. 2 conveys the received information to the central facility 106 via, for example, the network 122. Accordingly, the example instrumented application 110 of FIG. 2 provides the central facility 106 with monitoring data and user identifying information associated with the monitoring data. As described above, the example central facility 106 can use the received information to, for example, generate demographic metrics for detected media and/or application usage.

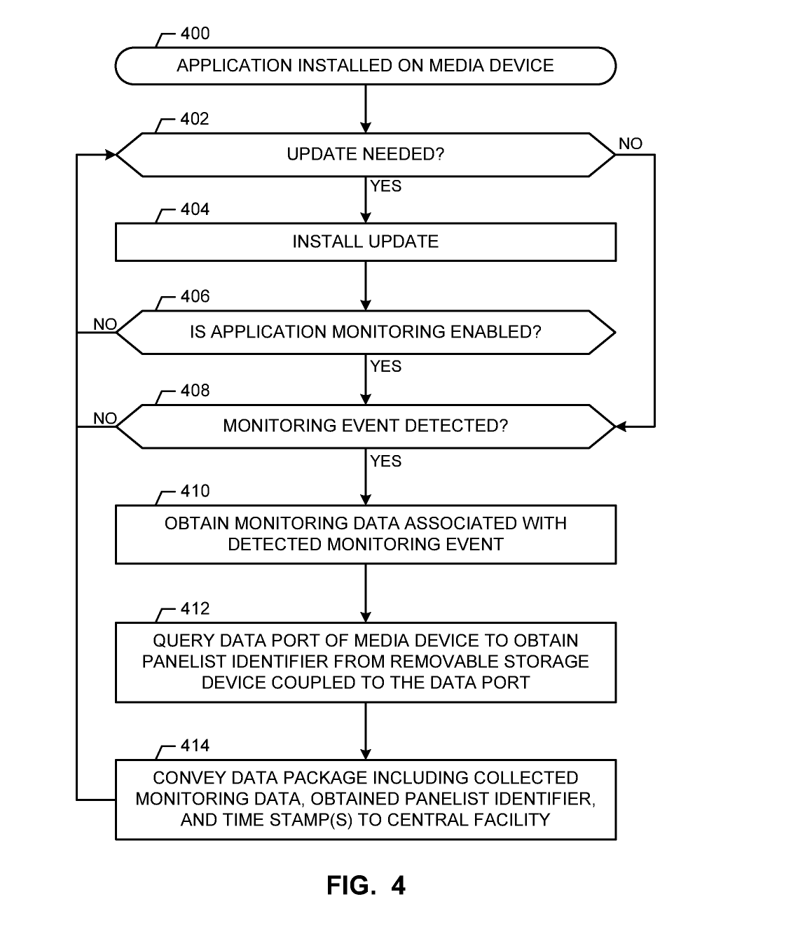

While an example manner of implementing the media device of FIG. 1 is illustrated in FIG. 2, one or more of the elements, processes and/or devices illustrated in FIG. 4 may be combined, divided, re-arranged, omitted, eliminated and/or implemented in any other way. Further, the example application 110, the example network communicator 200, the example media presenter 202, the example media monitor 204, the example usage monitor 206, the example identification retriever 208 and/or, more generally, the example media device 108 of FIG. 2 may be implemented by hardware, software, firmware and/or any combination of hardware, software and/or firmware. Thus, for example, any of the example application 110, the example network communicator 200, the example media presenter 202, the example media monitor 204, the example usage monitor 206, the example identification retriever 208 and/or, more generally, the example media device 108 of FIG. 2 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example application 110, the example network communicator 200, the example media presenter 202, the example media monitor 204, the example usage monitor 206, the example identification retriever 208 and/or, more generally, the example media device 108 of FIG. 2 is/are hereby expressly defined to include a tangible computer readable storage device or storage disk such as a memory, a digital versatile disk (DVD), a compact disk (CD), a Blu-ray disk, etc. storing the software and/or firmware. Further still, the example media device 108 of FIG. 1 may include one or more elements, processes and/or devices in addition to, or instead of, those illustrated in FIG. 2, and/or may include more than one of any or all of the illustrated elements, processes and devices.

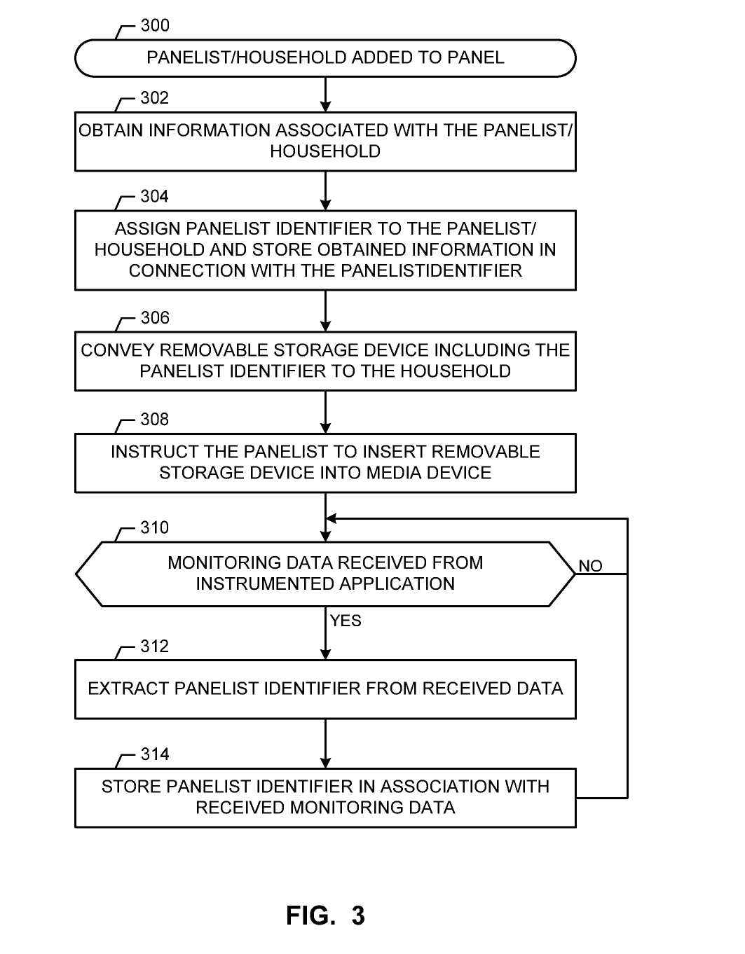

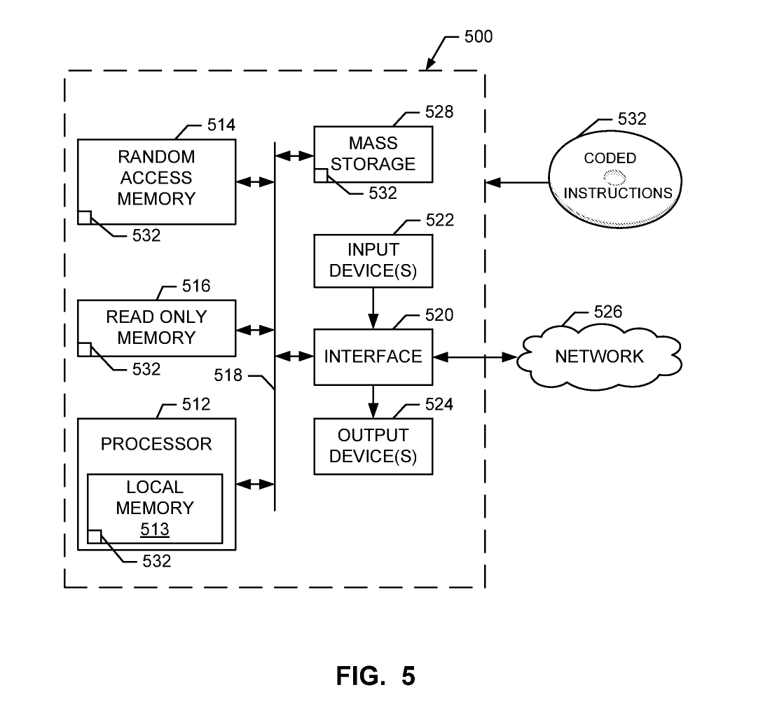

A flowchart representative of example machine readable instructions for implementing the central facility 106 of FIG. 1 is shown in FIG. 3. A flowchart representative of example machine readable instructions for implementing the media device 108 of FIGS. 1 and/or 2 is shown in FIG. 4. In these examples, the machine readable instructions comprise programs for execution by a processor such as the processor 512 shown in the example processor platform 500 discussed below in connection with FIG. 5. The programs may be embodied in software stored on a tangible computer readable storage medium such as a CD-ROM, a floppy disk, a hard drive, a digital versatile disk (DVD), a Blu-ray disk, or a memory associated with the processor 512, but the entire programs and/or parts thereof could alternatively be executed by a device other than the processor 512 and/or embodied in firmware or dedicated hardware. Further, although the example programs are described with reference to the flowcharts illustrated in FIGS. 3 and 4, many other methods of implementing the example central facility 106 and/or media device 108 may alternatively be used. For example, the order of execution of the blocks may be changed, and/or some of the blocks described may be changed, eliminated, or combined.

As mentioned above, the example processes of FIGS. 3 and 4 may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals. As used herein, “tangible computer readable storage medium” and “tangible machine readable storage medium” are used interchangeably. Additionally or alternatively, the example processes of FIGS. 3 and/or 4 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable device or disk and to exclude propagating signals. As used herein, when the phrase “at least” is used as the transition term in a preamble of a claim, it is open-ended in the same manner as the term “comprising” is open ended.

The example of FIG. 3 begins with the example panelist 104 and/or the example household 102 of FIG. 1 joining a panel implemented by an entity associated with the central facility 106 (block 300). The example panelist identification manager 118 of the central facility 106 obtains demographic from the panelist 104 and/or household 102 (block 302). For example, the panelist identification manager 118 provides a survey or questionnaire to the panelist 104 having questions regarding age, race, income, geographic location, preferences, etc. The example panelist identification manager 118 also assigns the panelist 104 and/or household 102 an identifier, such as the panelist identifier 114 of FIGS. 1 and/or 2 (block 304). The example panelist identification manager 118 stores the assigned identifier in the data store 120 in association with the obtained information related to the panelist 104 and/or household (block 304). The example panelist identification manager 118 facilitates placement (e.g., storage) of the assigned panelist identifier 114 onto the removable storage device 112. The example removable storage device 112 is provided to the corresponding panelist 104 and/or household 104 by, for example, mailing the removable storage device 112 (block 306). In the illustrated example, the central facility 106 instructs and/or requests the panelist 104 to insert the removable storage device 112 into the data port 116 of the media device 108 (block 308). In some examples, the panelist 104 inserting the removable storage device 112 into the media device 108 is considered consent for the monitoring entity to monitor the media device 108. In some examples, such consent is implied by the panelist 104 agreeing to join the panel.

As described above, the example central facility 106 has provided (e.g., via the SDK provider 130) instrumentation to applications, such as the example instrumented application 110 of FIG. 1, to cause the applications to retrieve the panelist identifier 114 from the removable storage device 112 in response to, for example, a monitoring event. Accordingly, the example monitoring data receiver 120 of the central facility 106 determines whether such information (e.g., monitoring data and/or the panelist identifier 114) has been received (block 310). If such data is received, the example monitoring data receiver 120 extract the panelist identifier 114 from the data (block 312). In some examples, extracting the panelist identifier 114 includes decrypted the received data obtain the panelist identifier 114. Additionally or alternatively, extracting the panelist identifier 114 includes analyzing a particular field of a data packet received from the media device 108. In the illustrated example, the monitoring data receiver 120 associates the extracted panelist identifier 114 with the accompanying monitoring data (e.g., media identifying information, application usage information, etc.) by, for example, storing the panelist identifier 114 and the accompanying monitoring data in an entry of the data store 120 and/or by assigning a shared label to the panelist identifier 114 and the accompanying monitoring data in the data store 120 (block 314). Control passes to block 310 to determine if more data has been received.

The example of FIG. 4 begins with the example application 110 of FIG. 1 being detected as installed on the example media device 108 of FIG. 1 (block 400). If an update for the application 110 is needed (e.g., as indicated by a message from the app store 128 of FIG. 1) (block 402), the update is downloaded and installed on the media device 108 (block 404). In some examples, the update includes one or more instrumentation instructions for the application 110 related to the monitoring functionality described above and/or one or more instrumentation instructions for the panelist identification functionality described above (e.g., retrieval of the panelist identifier 114 from the removable storage device 112 via the data port 116). In the example of FIG. 4, the media device 108 determines whether the monitoring functionality is enabled for the application 110 (block 406). In the example of FIG. 4, the monitoring functionality is enabled for the application 110 if the corresponding instrumentation (e.g., the media monitor 204, the usage monitor 206 and/or the identification retriever 208 of FIG. 2) has been integrated with the application 110 and if consent has been provided to monitor the application 110. In some examples, presence of the removable storage device 112 on the data port 116 is considered consent to the monitoring functionality. Additionally or alternatively, the example media device 108 prompts a user of the media device 108 as to whether consent is given to execute the monitoring functionality. If the monitoring functionality is not enabled for the application 110 (block 406), control passes to block 402. Otherwise, control passes to block 408.

When a monitoring event is detected by, for example, the media monitor 204 and/or the usage monitor 206 of FIG. 2 (block 408), the corresponding monitoring data is obtained (e.g., from a log associated with the application 110 and/or from the media presenter 202) (block 410). As described above, example monitoring data collected by the example instrumented application 110 includes media identifying information, usage statistics and/or characteristics, device identifying information, etc. In the example of FIG. 4, the identification retriever 208 of FIG. 2 queries the data port 116 of the media 108 to obtain the panelist identifier 114 from the removable storage device 112 (block 412). Accordingly, the example application 110 obtains user identifying information associated with the detected monitoring data. The example network communicator 200 of FIG. 2 transmits a data package including the collected monitoring data, the obtained panelist identifier 114 and/or time stamp(s) associated with the data to the central facility 106. Control passes to block 402.

Although for simplicity, the above discussion focuses on a single media device 108, a single instrumented application 110, a single media provider 126, a single app store 128, and a single central facility 106, any number of any of these elements may be present. For example, in a typical implementation, it is expected that multiple media providers will offer multiple different instrumented applications to the public at large. Thus, it is expected that there will be many media devices accessing such applications, and that a significant portion of the users will agree to be panelists. Thus, it is expected that there will be many instances of the above processes conducted across many devices at the overlapping and/or distinct times. Thus, for example, there may be many instantiations of the examples disclosed herein operating at the same or different time. Some of these instances may be implemented as parallel threads operating on a same device.

FIG. 5 is a block diagram of an example processor platform 500 capable of executing the instructions of FIG. 3 to implement the example central facility 106 of FIG. 1 and/or the instructions of FIG. 4 to implement the example media device 108 of FIGS. 1 and/or 2. The processor platform 500 can be, for example, an OTT media device, a personal computer, a mobile device (e.g., a cell phone, a smart phone, a tablet), a DVD player, a CD player, a digital video recorder, a Blu-ray player, a gaming console, a personal video recorder, a set top box, or any other type of computing device.

The processor platform 500 of the illustrated example includes a processor 512. The processor 512 of the illustrated example is hardware. For example, the processor 512 can be implemented by one or more integrated circuits, logic circuits, microprocessors or controllers from any desired family or manufacturer.

The processor 512 of the illustrated example includes a local memory 513 (e.g., a cache). The processor 512 of the illustrated example is in communication with a main memory including a volatile memory 514 and a non-volatile memory 516 via a bus 518. The volatile memory 514 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 516 may be implemented by flash memory and/or any other desired type of memory device. Access to the main memory 514, 516 is controlled by a memory controller.

The processor platform 500 of the illustrated example also includes an interface circuit 520. The interface circuit 520 may be implemented by any type of interface standard, such as an Ethernet interface, a universal serial bus (USB), and/or a PCI express interface.

In the illustrated example, one or more input devices 522 are connected to the interface circuit 520. The input device(s) 522 permit(s) a user to enter data and commands into the processor 512. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 524 are also connected to the interface circuit 520 of the illustrated example. The output devices 524 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 520 of the illustrated example, thus, typically includes a graphics driver card, a graphics driver chip or a graphics driver processor.

The interface circuit 520 of the illustrated example also includes a communication device such as a transmitter, a receiver, a transceiver, a modem and/or network interface card to facilitate exchange of data with external machines (e.g., computing devices of any kind) via a network 526 (e.g., an Ethernet connection, a digital subscriber line (DSL), a telephone line, coaxial cable, a cellular telephone system, etc.).

The processor platform 500 of the illustrated example also includes one or more mass storage devices 528 for storing software and/or data. Examples of such mass storage devices 528 include floppy disk drives, hard drive disks, compact disk drives, Blu-ray disk drives, RAID systems, and digital versatile disk (DVD) drives.

The coded instructions 532 of FIGS. 3 and/or 4 may be stored in the mass storage device 528, in the volatile memory 514, in the non-volatile memory 516, and/or on a removable tangible computer readable storage medium such as a CD or DVD.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A media device comprising:
a data port to receive a removable storage device; and
an application instrumented to:
obtain first data associated with a monitoring event of the application;
reference the data port to retrieve a panelist identifier from the removable storage device in response to the monitoring event; and
convey the first data and the panelist identifier to a remote computer, wherein the media device comprises an Overt the Top device.

2. A media device as defined in claim 1, wherein the remote computer is associated with a provider of the removable storage device, the provider comprising a monitoring entity that assigned the panelist identifier to a panelist.

3. A media device as defined in claim 1, wherein the data port comprises a Universal Serial Bus (USB) receptacle, and the removable storage device comprises a (USB) drive.

4. A media device as defined in claim 1, wherein the application is instrumented to associated the panelist identifier with the first data.

5. A media device as defined in claim 1, wherein the monitoring event corresponds to a media presentation, and the first data comprises media identifying information corresponding to the media presentation.

6. A media device as defined in claim 1, wherein the monitoring event corresponds to an interaction with a social networking service via the application, and the first data comprises information corresponding to the interaction.

7. A tangible computer readable storage medium comprising instructions that, when executed, cause a machine to at least:
obtain first data associated with a monitoring event of an application on a media device having a data port to receive a removable storage device;
reference the data port to retrieve a panelist identifier from the removable storage device in response to the monitoring event; and
convey the first data and the panelist identifier to remote computer, wherein the media device comprises an Over the Top device.

8. A storage medium as defined in claim 7, wherein the remote computer is associated with a provider of the removable storage device, the provider comprising a monitoring entity that assigned the panelist identifier to a panelist.

9. A storage medium as defined in claim 7, wherein the data port comprises a Universal Serial Bus (USB) receptacle, and the removable storage device comprises a (USB) drive.

10. A storage medium as defined in claim 7, wherein the instructions cause the machine to associate the panelist identifier with the first data.

11. A storage medium as defined in claim 7, wherein the monitoring event corresponds to a media presentation, and the first data comprises media identifying information corresponding to the media presentation.

12. A storage medium as defined in claim 7, wherein the monitoring event corresponds to an interaction with a social networking service via the application, and the first data comprises information corresponding to the interaction.

13. A method comprising:
obtaining first data associated with a monitoring event of an application on a media device having a data port to receive a removable storage device;
retrieving a panelist identifier from the removable storage device in response to the monitoring event; and
conveying the first data and the panelist identifier to a provider of the removable storage device, wherein the media device comprises an Over the Top device.

14. A method as defined in claim 13, wherein the provider of the removable storage device comprises a monitoring entity that assigned the panelist identifier to a panelist.

15. A method as defined in claim 13, wherein the data port comprises a Universal Serial Bus (USB) receptacle, and the removable storage device comprises a (USB) drive.

16. A method as defined in claim 13, further comprising associating the panelist identifier with the first data.

17. A method as defined in claim 13, wherein the monitoring event corresponds to a media presentation, and the first data comprises media identifying information corresponding to the media presentation

18. A method as defined in claim 13, wherein the monitoring event corresponds to an interaction with a social networking service via the application, and the first data corresponds to the interaction.

19. A media device comprising:
a data port to receive a removable storage device; and
an application instrumented to:
obtain first data associated with a monitoring event of the application;
reference the data port to retrieve a panelist identifier from the removable storage device in response to the monitoring event; and
convey the first data and the panelist identifier to a remote computer, wherein the monitoring event corresponds to an interaction with a social networking service via the application, and the first data comprises information corresponding to the interaction.

20. A tangible computer readable storage medium comprising instructions that, when executed, cause a machine to at least:
obtain first data associated with a monitoring event of an application on a media device having a data port to receive a removable storage device;
reference the data port to retrieve a panelist identifier from the removable storage device in response to the monitoring event; and
convey the first data and the panelist identifier to remote computer, wherein the monitoring event corresponds to an interaction with a social networking service via the application, and the first data comprises information corresponding to the interaction.

21. A method comprising:
obtaining first data associated with a monitoring event of an application on a media device having a data port to receive a removable storage device;
retrieving a panelist identifier from the removable storage device in response to the monitoring event; and
conveying the first data and the panelist identifier to a provider of the removable storage device, wherein the monitoring event corresponds to an interaction with a social networking service via the application, and the first data corresponds to the interaction.
